(19) United States
(12) Patent Application Publication
(10) Pub. No.: US 2023/0400725 A1
(43) Pub. Date: Dec. 14, 2023

(54) DISPLAY DEVICE

(71) Applicant: WUHAN CHINA STAR OPTOELECTRONICS TECHNOLOGY CO.,LTD., Wuhan (CN)

(72) Inventors: Zheng Zhou, Wuhan (CN); Suimang Song, Wuhan (CN)

(73) Assignee: WUHAN CHINA STAR OPTOELECTRONICS TECHNOLOGY CO.,LTD., Wuhan (CN)

(21) Appl. No.: 17/431,106

(22) PCT Filed: Jun. 4, 2021
(86) PCT No.: PCT/CN2021/098403

§ 371 Date: Nov. 24, 2022

(30) Foreign Application Priority Data
May 19, 2021 (CN) 202110544760.9

(51) Int. Cl. G02F 1/1333; G02F 1/1335

(52) U.S. Cl. CPC G02F 1/133308; G02F 1/133504

(57) ABSTRACT

A display device is provided. The display device includes an inner frame and an optical component. The inner frame includes a bearing surface for carrying the optical component and a limiting surface for limiting the optical component. The limiting surface and the bearing surface are arranged opposite to define an accommodation space to accommodate the optical component. The bearing surface and the limiting surface are both curved surfaces, and a distance between the bearing surface and the limiting surface matches a thickness of the optical component.

### FIELD OF INVENTION

This application relates to a field of display technology, in particular to a display device.

### BACKGROUND OF INVENTION

Diffuser plates currently used in market are usually flat structures, which cannot meet requirements for curved display devices. How to obtain a curved diffuser plate with a fixed curvature in a large-size curved display module has become an urgent technical problem in industry.

### TECHNICAL PROBLEM

An embodiment of the present application provides a display device to solve the technical problem that the curved diffuser plate with the fixed curvature is difficult to obtain in prior art.

### SUMMARY OF INVENTION

An embodiment of the present application provides a display device, including an inner frame and an optical component, wherein the inner frame includes a bearing surface for carrying the optical component and a limiting surface for limiting the optical component, the limiting surface and the bearing surface are arranged opposite to define an accommodation space to accommodate the optical component; the bearing surface and the limiting surface are both curved surfaces, and a distance between the bearing surface and the limiting surface matches a thickness of the optical component.

Optionally, in some embodiments of the present application, the inner frame includes a bottom frame and a limiting frame arranged in a stack, the bearing surface includes a surface of the bottom frame facing the optical component, and the limiting surface includes a surface of the limiting frame facing the optical component; the inner frame includes a first side wall, a second side wall, and a third side wall, the first side wall is disposed opposite to the third side wall, and the second side wall is connected between the first side wall and the third side wall; the first side wall, the second side wall, the third side wall, the bearing surface, and the limiting surface jointly define the accommodation space; the limiting frame further includes at least one protrusion portion, the protrusion portion is disposed on the first side wall and/or the third side wall, a protruding direction of the protrusion portion faces a side wall opposite to the protrusion portion, and the limiting surface includes a surface of the protrusion portion facing the bearing surface.

Optionally, in some embodiments of the present application, the protrusion portion has a first end and a second end, the first end is an end of the protrusion portion connected to the first side wall or the third side wall, the second end is a free end of the protrusion portion, a cross-sectional area of the first end is greater than a cross-sectional area of the second end.

Optionally, in some embodiments of the present application, a surface of the protrusion portion away from the bearing surface is flush with an upper surface of the first side wall or an upper surface of the third side wall.

Optionally, in some embodiments of the present application, both the first side wall and the third side wall are provided with protrusion portions distributed at intervals, the limiting surface includes surfaces of the protrusion portions close to the bearing surface, the surface of each protrusion portion close to the bearing surface is a curved surface; the display device further includes a display panel disposed on the optical component, a distance between the protrusion portion far away from a side wall of the inner frame and the display panel is greater than a distance between the protrusion portion close to the side wall of the inner frame and the display panel.

Optionally, in some embodiments of the present application, the inner frame includes a bottom frame and a limiting frame arranged in a stack, the bearing surface includes a surface of the bottom frame facing the optical component, and the limiting surface includes a surface of the limiting frame facing the optical component; the inner frame includes a first side wall, a second side wall, a third side wall, and a fourth side wall connected in sequence, the first side wall is disposed opposite to the third side wall, the first side wall, the second side wall, the third side wall, the bearing surface, and the limiting surface jointly define the accommodation space; the accommodation space has an opening above the fourth side wall, the accommodation space communicates with outside of the inner frame through the opening, an adhesive member is provided on the fourth side wall, and one end of the optical component is fixed to the inner frame through the adhesive member.

Optionally, in some embodiments of the present application, the inner frame includes a first side wall, a second side wall, and a third side wall, the first side wall and the third side wall are arranged opposite to each other, and the first side wall, the second side wall, the third side wall, the bearing surface, and the limiting surface jointly define the accommodation space; the inner frame further includes at least one buffer portion located on one or more of the first side wall, the second side wall, and the third side wall, and the buffer portion abuts against a side surface of the optical component.

Optionally, in some embodiments of the present application, the buffer portion is disposed on the second side wall, and the buffer portion includes a buffer groove formed on the second side wall; a surface of the second side wall facing the accommodation space abuts against the side surface of the optical component.

Optionally, in some embodiments of the present application, a surface of the second side wall close to the accommodation space protrudes toward the accommodation space to form a protrusion portion, an orthographic projection of the protrusion portion on the second side wall overlaps the buffer groove, one end of the protrusion portion extends to the bearing surface, and another end of the protrusion portion extends in a direction away from the bearing surface.

Optionally, in some embodiments of the present application, a surface of the protrusion portion facing the accommodation space is a curved surface, a distance between a vertex of the curved surface of the protrusion portion facing the accommodation space and the bearing surface is half of a thickness of a diffuser plate in the optical component.

Optionally, in some embodiments of the present application, the distance between the bearing surface and the limiting surface matches the thickness of the optical component includes: the accommodation space accommodates the optical component, and the optical component is bent according to a preset curvature under a limiting action of the bearing surface and the limiting surface.

An embodiment of the present application further provides a display device, including an inner frame and an optical component, wherein the inner frame includes a bearing surface for carrying the optical component and a limiting surface for limiting the optical component, the inner frame includes a bottom frame and a limiting frame arranged in a stack, the bearing surface includes a surface of the bottom frame facing the optical component, and the limiting surface includes a surface of the limiting frame facing the optical component; the limiting surface and the bearing surface are arranged opposite to define an accommodation space to accommodate the optical component; the bearing surface and the limiting surface are both curved surfaces, the optical component is bent according to a preset curvature under a limiting action of the bearing surface and the limiting surface; the inner frame includes a first side wall, a second side wall, and a third side wall, the first side wall and the third side wall are arranged opposite to each other, and the second side wall is connected between the first side wall and the third side wall; the first side wall, the second side wall, the third side wall, the bearing surface, and the limiting surface jointly define the accommodation space.

Optionally, in some embodiments of the present application, the limiting frame further includes at least one protrusion portion, the protrusion portion is disposed on the first side wall and/or the third side wall, a protruding direction of the protrusion portion faces a side wall opposite to the protrusion portion, and the limiting surface includes a surface of the protrusion portion facing the bearing surface.

Optionally, in some embodiments of the present application, a thickness of the protrusion portion ranges from 0.5 mm to 1 mm.

Optionally, in some embodiments of the present application, the inner frame further includes at least one buffer portion located on one or more of the first side wall, the second side wall, and the third side wall, and the buffer portion abuts against a side surface of the optical component.

Optionally, in some embodiments of the present application, the buffer portion is disposed on the second side wall, and the buffer portion includes a buffer groove formed on the second side wall; a surface of the second side wall close to the accommodation space protrudes toward the accommodation space to form a protrusion portion, an orthographic projection of the protrusion portion on the second side wall overlaps the buffer groove, one end of the protrusion portion extends to the bearing surface, and another end of the protrusion portion extends in a direction away from the bearing surface.

Optionally, in some embodiments of the present application, a surface of the protrusion portion facing the accommodation space is a curved surface, a distance between a vertex of the curved surface of the protrusion portion facing the accommodation space and the bearing surface is half of a thickness of a diffuser plate in the optical component.

Optionally, in some embodiments of the present application, the inner frame includes the first side wall, the second side wall, the third side wall, and the fourth side wall connected in sequence, the second side wall is opposite to the fourth side wall; the accommodation space has an opening above the fourth side wall, the accommodation space communicates with outside of the inner frame through the opening, an adhesive member is provided on the fourth side wall, and one end of the optical component is fixed to the inner frame through the adhesive member.

Optionally, in some embodiments of the present application, each of the first side wall, the second side wall, and the third side wall includes a bottom frame side wall and a limiting frame side wall, the fourth side wall includes a bottom frame side wall, the opening extends from above the fourth side wall to above the bottom frame side wall of the first side wall and above the bottom frame side wall of the third side wall; the bottom frame side walls of the first side wall, the second side wall, the third side wall, and the fourth side wall enclose to form a light source accommodation space, the light source accommodation space accommodates a light source assembly; the limiting frame side walls of the first side wall, the second side wall, and the third side wall enclose to form the accommodation space.

Optionally, in some embodiments of the present application, a distance between the bearing surface and the limiting surface is a fixed value.

### BENEFICIAL EFFECT

The beneficial effects of this application are:

In this application, the bearing surface and the limiting surface of the inner frame are designed as curved surfaces, and the distance between the bearing surface and the limiting surface is determined according to the thickness of an optical component, which ensures that the optical component is bent under the limiting action of the bearing surface, and the bending curvature is always kept constant. This design of the present application fills the gap in the completion of optical components bending in the module manufacturing process in the industry. The curved optical component matching the curved display panel can be obtained through current module manufacturing process without adding an additional manufacturing process, which greatly improves the optical performance of the large-size curved display device.

### DESCRIPTION OF DRAWINGS

In order to more clearly describe the technical solutions in the embodiments of the present application, the following will briefly introduce the drawings that need to be used in the description of the embodiments. Obviously, the drawings in the description are only some embodiments of the invention. For one of ordinary skill in the art, other drawings can be obtained based on these drawings without paying creative work.

FIG. 1 is a schematic cross-sectional view of a display device provided by a specific embodiment of the present application.

FIG. 2 is a schematic cross-sectional view of an inner frame in the display device provided in FIG. 1.

FIG. 3 is a cross-sectional view of a second side wall of the inner frame in FIG. 1.

FIG. 4 is a cross-sectional view of a fourth side wall of the inner frame in FIG. 1. FIG. 5 is a top view of the inner frame in FIG. 1 when no optical component is placed.

FIG. 6 is a cross-sectional view of the inner frame in FIG. 5 at A-A position.

FIG. 7 is a partially enlarged view of part A in FIG. 1.

FIG. 8 is a partially enlarged view of part B in FIG. 1.

FIG. 9 is a top view of the optical component in FIG. 1 when it is placed in the inner frame and expanded by heat.

### DETAILED DESCRIPTION OF PREFERRED EMBODIMENTS

The following will clearly and completely describe the technical solutions in the embodiments of the present application with reference to the drawings in the embodiments of the present application. Obviously, the embodiments are only part of the embodiments of the present application, rather than all the embodiments. Based on these embodiments in this application, all other embodiments obtained by those skilled in the art without paying creative work shall fall within the protection scope of this application.

This application provides a display device including an inner frame and an optical component. The inner frame includes a bearing surface for bearing the optical component and a limiting surface for limiting the optical component. The limiting surface and the bearing surface are arranged opposite to define an accommodation space. The accommodation space is used for accommodating the optical component. Both the bearing surface and the limiting surface are curved surfaces. The distance between the bearing surface and the limiting surface matches the thickness of the optical component. In this application, the limiting surface and the bearing surface are designed as curved surfaces to define an accommodation space curved according to a preset curvature, thereby forcing the optical component placed in the accommodation space to bend according to the preset curvature.

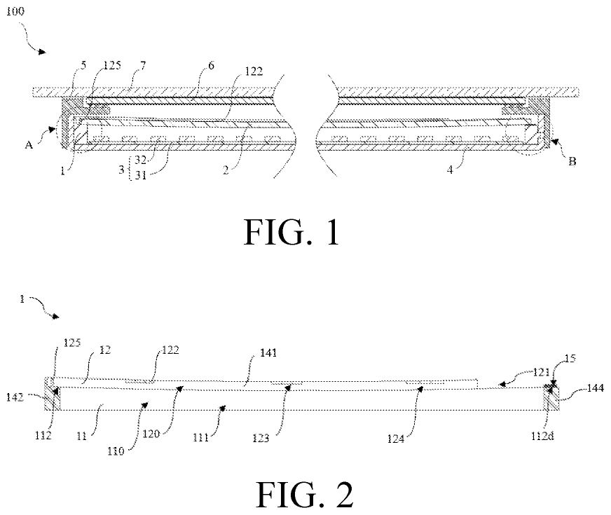

This application provides a specific embodiment as shown in FIG. 1 to FIG. 9. A display device 100 is provided, including an inner frame 1, an optical component 2, a light source assembly 3, a backplate 4, an outer frame 5, a display panel 6, and a cover plate 7.

The optical component 2 is placed in the inner frame 1. A diffuser plate 21 in the optical component 2 is arranged close to the light source assembly 3. Other optical films are attached layer by layer to the surface of the diffuser plate 21 away from the light source assembly 3.

The light source assembly 3 includes a light board 31 and a plurality of light sources 32. The plurality of light sources 32 are fixed on the light board 31 at intervals. The light board 31 is attached to the backplate 4 through a thermally conductive glue (not shown in the figure). The light source 32 can be a mini-LED lamp. In other specific embodiments of the present application, the light source 32 may also be a bar-shaped light source or a whole-surface light source, which is not specifically limited herein.

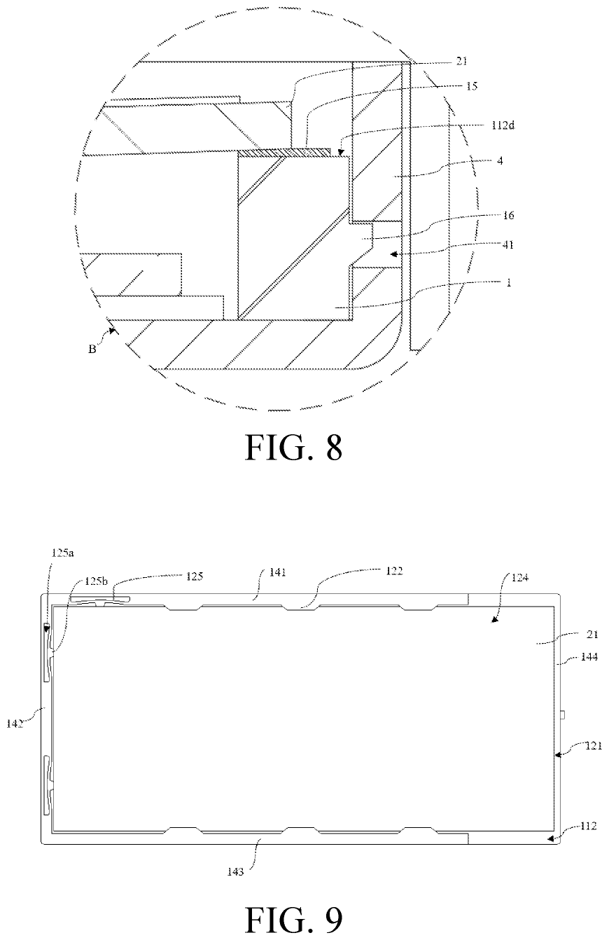

The inner frame 1 can be detachably fixed on the backplate 4. With reference to FIG. 8, the inner frame 1 includes a snap portion 16 provided on the side wall. A surface of the inner frame 1 close to the backplate 4 protrudes toward the backplate 4 to form the snap portion 16. Correspondingly, a limiting hole 41 is provided on the backplate 4. The inner frame 1 is detachably connected with the backplate 4 by snapping the snap portion 16 into the limiting hole 41. It can be understood that the limiting hole 41 may be a through-hole as shown in the figure, or a blind hole, which is not specifically limited herein.

The outer frame 5 is detachably fixed on the outside of the backplate 4. In this embodiment, the outer frame 5 and the backplate 4 can be fixed by a snap structure, a threaded structure, or an interference fit, which is not specifically limited in this application.

Both ends of the display panel 6 are fixed on the outer frame 5 by adhesive tapes. When display panel 6 is a liquid crystal display panel, it includes an upper polarizer, a color filter substrate, an array substrate, and a lower polarizer.

The cover plate 7 covers a light-emitting surface of the display panel 6 to protect the display panel 6. The cover plate 7 and the display panel 6 are bonded and fixed by transparent optical glue, which can be realized by optically clear resin (OCR) glue or optical clear adhesive (OCA) glue.

As shown in FIG. 1 and FIG. 2, the inner frame 1 includes a bottom frame 11 and a limiting frame 12 that are stacked. The limiting frame 12 is arranged on a side of the bottom frame 11 close to the display panel 6.

The inner frame 1 includes a first side wall 141, a second side wall 142, a third side wall 143, and a fourth side wall 144 connected in sequence. With reference to FIG. 5, the first side wall 141 is opposite to the third side wall 143, and the second side wall 142 is opposite to the fourth side wall 144.

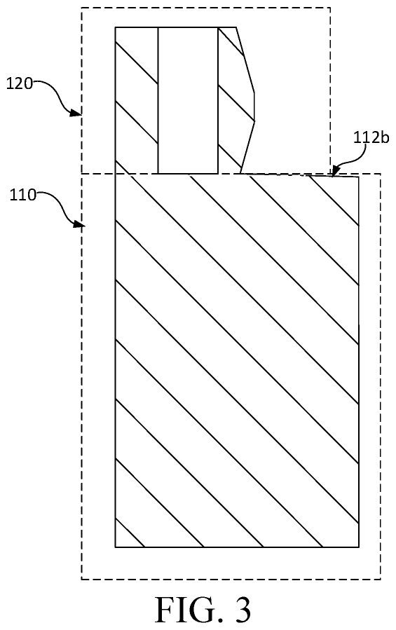

FIG. 3 shows a cross-sectional view of the second side wall 142 of the inner frame 1. The second side wall of the inner frame 1 includes a bottom frame side wall 110 and a limiting frame side wall 120. The limiting frame side wall 120 is stacked on the bottom frame side wall 110. The bottom frame side wall 110 and the limiting frame side wall 120 are integrally formed. The thickness of the bottom frame side wall 110 is greater than the thickness of the limiting frame side wall 120. In a thickness direction of the side wall, the bottom frame side wall 110 has a second bearing surface 112b protruding from the limiting frame side wall 120.

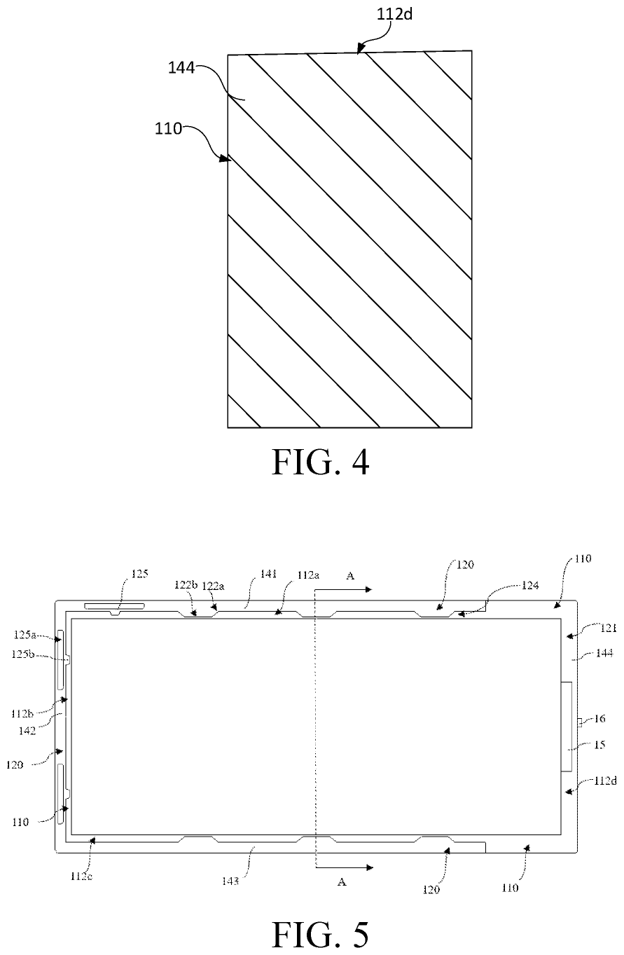

FIG. 4 shows a cross-sectional view of the fourth side wall 144 of the inner frame 1. The fourth side wall 144 includes the bottom frame side wall 110, but no limiting frame side wall 120 is provided, so that the limiting frame 12 has an opening 121 above the fourth side wall 144. The bottom frame side wall 110 of the fourth side wall 144 has a fourth bearing surface 112d.

With reference to FIG. 2 and FIG. 5, the second side wall 142 everywhere includes a bottom frame side wall 110 and a limiting frame side wall 120. The portions of the first side wall 141 and the third side wall 143 close to the second side wall 142 include the bottom frame side wall 110 and the limiting frame side wall 120. The portions of the first side wall 141 and the third side wall 143 close to the fourth side wall 144 only include the bottom frame side wall 110 to enlarge the opening 121 and further facilitate the picking and placement of the optical component 2.

Wherein, the bottom frame 11 is formed by encircling the bottom frame side walls of the first side wall 141, the second side wall 142, the third side wall 143, and the fourth side wall 144 on four sides. The limiting frame 12 is encircled by the limiting frame side walls of the first side wall 141, the second side wall 142, and the third side wall 143 on three sides to form a structure with an opening 121. The limiting frame 12 has an opening 121 above the fourth side wall 144 for the optical component 2 to be inserted between the limiting frame 12 and the bottom frame 11 from the outside.

The bottom frame side walls 110 on four sides of the bottom frame 11 are encircled to form a light source accommodation space 111. The bearing surface 112 includes a surface of the bottom frame side wall 110 of the bottom frame 11 facing the optical component 2. Specifically, the bearing surface 112 includes a surface supporting the optical component 2 on the bottom frame side walls 110 of the first side wall 141, the second side wall 142, the third side wall 143, and the fourth side wall 144. In order to match the demand for curved optical component in the curved display device, the bearing surface 112 is designed as a curved surface.

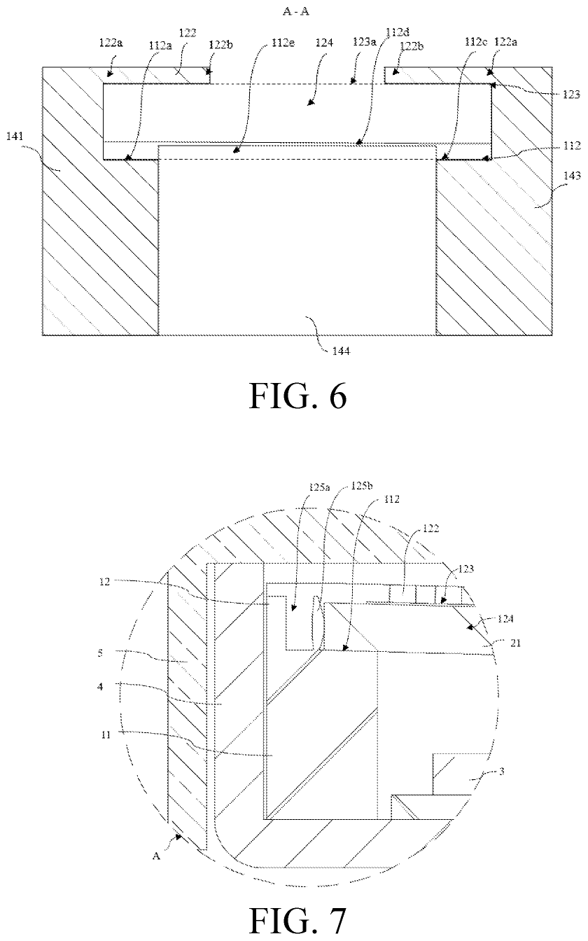

The bearing surface 112 is configured to face the optical component 2. The bearing surface 112 is used to carry and fix the optical component 2. With reference to FIG. 2 and FIG. 5, the bearing surface 112 includes a first bearing surface 112a on the first side wall 141, a second bearing surface 112b on the second side wall 142, a third bearing surface 112c on the third side wall 143, and a fourth bearing surface 112d on the fourth side wall 144. The first bearing surface 112a, the second bearing surface 112b, the third bearing surface 112c, and the fourth bearing surface 112d are all in contact with an edge of the optical component 2 to achieve stable support for the optical component 2. It can be understood that the first bearing surface 112a, the second bearing surface 112b, the third bearing surface 112c, and the fourth bearing surface 112d have the same curvature. The bearing surface 112 is a curved surface coplanar with the first bearing surface 112a, the second bearing surface 112b, the third bearing surface 112c, and the fourth bearing surface 112d. The first bearing surface 112a, the second bearing surface 112b, the third bearing surface 112c, and the fourth bearing surface 112d jointly define the bearing surface 112. As shown in FIG. 6, the bearing surface 112 includes a physical bearing surface represented by the first bearing surface 112a, etc., and also includes a virtual bearing surface 112e located between adjacent physical bearing surfaces. It should be noted that the virtual bearing surface 112e is coplanar with the physical bearing surface and is defined by multiple physical bearing surfaces.

The limiting frame 12 is disposed on the bearing surface 112 of the bottom frame 11. In this embodiment, the bottom frame 11 and the limiting frame 12 are fixed in an integrated manner. It can be understood that the bottom frame 11 and the limiting frame 12 may also be connected in other ways, such as threaded connection, snap connection, etc., which are not specifically limited herein.

The limiting frame 12 is a structure with an opening 121 encircled by the limiting frame side walls 120 of the first side wall 141, the second side wall 142, and the third side wall 143. At least one protrusion portion 122 is provided on the first side wall 141 and the third side wall 143, respectively. The protrusion portion 122 is configured to limit the position of the optical component 2 in a direction perpendicular to the bearing surface 112 to force the optical component 2 to bend according to a preset curvature. The limiting surface 123 includes a surface of the protrusion portion 122 opposite to the bearing surface 112. The limiting surface 123 is a curved surface. The distance between the limiting surface 123 and the bearing surface 112 matches the thickness of the optical component 2.

The protrusion portion 122 protrudes from an inner surface of the first side wall 141 or the third side wall 143 toward the side wall opposite to the protrusion portion. Specifically, the protrusion portion 122 located on the first side wall 141 protrudes toward the third side wall 143, and the protrusion portion 122 located on the third side wall 143 protrudes toward the first side wall 141. The limiting surface 123 includes a surface of the protrusion portion 122 facing the bearing surface 112.

When there are multiple protrusion portions 122 on the limiting frame 12, the limiting surface 123 is formed by the surfaces of the protrusion portions 122 opposite to the bearing surface 112. It can be understood that the surfaces of the protrusion portions 122 opposite to the bearing surface 112 have the same curvature. The limiting surface 123 is a curved surface coplanar with the protrusion portions 122. The curved surface defined by the curved surfaces of the protrusion portions 122 opposite to the bearing surface 112 is the limiting surface 123. As shown in FIG. 6, the limiting surface 123 includes a physical limiting surface represented by the surface of the protrusion portion 122 facing the bearing surface 112 and also includes a virtual limiting surface 123a located between adjacent physical limiting surfaces. It should be noted that the virtual limiting surface 123a is coplanar with the physical limiting surface. The virtual limiting surface 123a is also defined by a plurality of physical bearing surfaces. In this embodiment, the virtual limiting surface 123a is located between the surfaces of the two adjacent protrusion portions 122 facing the bearing surface 112.

In a specific embodiment of the present application, the spacing distances between adjacent protrusion portions 122 are equal to ensure that the plurality of protrusion portions 122 uniformly limit the position of the optical component 2. The thickness of the plurality of protrusion portions 122 may be the same or different, as long as the surfaces of the plurality of protrusion portions 122 facing the bearing surface 112 are coplanar, which is not specifically limited herein.

It can be understood that the thickness of the plurality of protrusion portions 122 may be the same or different as long as the surfaces of the plurality of protrusion portions 122 facing the bearing surface 112 are coplanar, which is not specifically limited herein. In this embodiment, the thickness of the protrusion portions 122 range from 0.5 mm to 1 mm Specifically, it can be 0.62 mm, 0.7 mm, 0.8 mm, 0.85 mm, 0.9 mm, etc. To improve the strength of the protrusion portions 122, the thickness of the protrusion portions 122 may be set to range from 0.7 mm to 0.9 mm.

The protrusion portion 122 has a first end 122a and a second end 122b. The first end 122a is an end of the protrusion portion 122 connected to the first side wall 141 or the third side wall 143. The second end 122b is a free end of the protrusion portion 122. The cross-sectional area of the first end 122a is set to be greater than the cross-sectional area of the second end 122b so that the second end 122b close to the optical component 2 has an obtuse angle structure. As shown in FIG. 5, the protrusion portion 122 is designed as an isosceles trapezoid structure in a top view to ensure that the second end close to the optical component 2 has an obtuse angle structure. In this way, the acute angle or right-angle structure can be prevented from being too sharp and damaging the surface of the optical component 2.

With reference to FIG. 2 and FIG. 5, the surface of the protrusion portion 122 away from the bearing surface 112 is flush with the upper surface of the first side wall 141 or the third side wall 143 where it is located, so as to form a relatively flat surface for contact with other structures of the display device 100. In other embodiments of the present application, the surface of the protrusion portion 122 away from the bearing surface 112 may not be flush with the upper surface of the first side wall 141 or the third side wall 143 as long as it does not affect the subsequent assembly of the display device, which is not specifically limited herein.

It can be understood that the second side wall 142 may also be provided with the protrusion portion 122 to further limit the position of the optical component 2.

With reference to FIG. 6, the limiting frame side wall 120 of the first side wall 141, the second side wall 142, and the third side wall 143 together with the bearing surface 112 and the limiting surface 123 define an accommodation space 124. The dashed box in FIG. 6 shows the accommodation space 124 at A-A position. The fourth side wall 144 merely extends to the fourth bearing surface 112d of the bottom frame 11, so that the accommodation space 124 communicates with the outside of the inner frame 1 through the opening 121 above the fourth side wall 144. The optical component 2 is placed in the accommodation space 124 through the opening 121. In order to facilitate the optical component 2 to be inserted into the accommodation space 124, the first side wall 141 and the third side wall 143 have no limiting frame side wall 120 at an end close to the fourth side wall 144 to enlarge the width of the opening 121. It can be understood that the length of the opening 121 in the length direction of the first side wall 141 is less than half of the length of the first side wall 141, and the length of the opening 121 in the length direction of the third side wall 143 is less than half of the length of the third side wall 143. In other words, in the length direction, at least half of the first side wall 141 or the third side wall 143 has the limiting frame side wall 120.

In order to ensure that the accommodation space 124 can accurately limit the position of the optical component 2 while accommodating the optical component 2, forcing the optical component 2 to bend according to the preset curvature and maintain the preset curvature unchanged, the distance between the bearing surface 112 and the limiting surface 123 should match the thickness of the optical component 2. In the specific embodiment of the present application, the distance between the bearing surface 112 and the limiting surface 123 should match the thickness of the optical component 2 and the following requirements must also be met:
1. Ensure that the optical component 2 can be smoothly placed in the accommodation space 124.
2. The optical component 2 can be bent according to a preset curvature under the limiting action of the bearing surface 112 and the limiting surface 123.
3. The distance between the bearing surface 112 and the limiting surface 123 needs to reserve a space for the thermal expansion of the optical component 2.

Generally speaking, the distance between the bearing surface 112 and the limiting surface 123 should be slightly greater than the thickness of the optical component 2. Specifically, the distance between the bearing surface 112 and the limiting surface 123 is 0.5 mm to 2 mm greater than the thickness of the optical component 2.

In this embodiment, the preset curvature is determined by the curvature and thickness of the curved display panel 6 and the thickness of the optical component 2. The preset curvature of the optical component 2 should match the bending curvature of the display panel 6 to improve the display effect of the display panel.

In order to ensure that the curvature of the limiting surface 123 jointly defined by the plurality of protrusion portions 122 matches the preset curvature of the optical component 2, the distance between the protrusion portions 122 far away from the side wall of the inner frame 1 and the display panel 6 is greater than the distance between the protrusion portion 122 close to the side wall of the inner frame 1 and the display panel 6.

The distance between the bearing surface 112 and the limiting surface 123 is a fixed value to ensure that the accommodation space 124 can accurately limit the position of the optical component 2. In order to match the curved state of the curved display panel, the bearing surface 112 and the limiting surface 123 as a whole present a state where the middle is low and the two ends are high.

With reference to FIG. 7, at least one buffer portion 125 is provided on the second side wall 142. The buffer portion 125 is used to abut against a side surface of the optical component 2 to buffer an external force that the optical component 2 bears in a horizontal direction. In addition, when the temperature of the display device 100 rises, the diffuser plate 21 will be thermally expanded and deformed, and the buffer portion 125 can prevent the diffuser plate 21 from being abnormally warped due to expansion.

The buffer portion 125 includes a buffer groove 125a defined on the upper surface of the second side wall 142. The surface of the second side wall 142 facing the accommodation space 124 abuts against the side surface of the optical component 2. The plane of the bottom of the buffer groove 125a is flush with or lower than the bearing surface 112 to increase the buffering capacity of the buffer portion 125.

The surface of the second side wall 142 close to the accommodation space 124 protrudes toward the accommodation space 124 to form a protrusion portion 125 b. One end of the protrusion portion 125b extends to the bearing surface 112, and the other end of the protrusion portion 125b extends to the surface of the second side wall 142 in a direction away from the bearing surface 112. The surface of the protrusion portion 125b facing the accommodation space 124 is a curved surface, and a distance between the vertex of the curved surface of the protrusion portion 125b facing the accommodation space 124 and the bearing surface 112b is half the thickness of the diffuser plate 21. That is, when the protrusion portion 125b abuts the optical component 2, the vertex of the curved surface of the surface where the protrusion portion 125b abuts the optical component 2 is located on the centerline of the diffuser plate 21. Therefore, the buffer portion 125 can not only buffer the external force borne by the optical component 2 in the horizontal direction, but also reduce the contact area between the buffer portion 125 and the diffuser plate 21 to improve the buffering capacity of the buffer portion 125.

In this embodiment, the thickness of the protrusion portion 125b in the horizontal direction ranges from 0.3 mm to 0.7 mm Specifically, it can be 0.35 mm, 0.4 mm, 0.5 mm, 0.65 mm, and so on. In order to obtain a stronger buffering capacity, the thickness of the protrusion portion 125b in the horizontal direction may range from mm to 0.6 mm.

In one embodiment, both the first side wall 141 and the second side wall 142 are provided with at least one buffer portion 125, so as to buffer the external force and the deformation pressure caused by thermal expansion of the optical component 2 in multiple directions. It can be understood that, in other embodiments of the present application, at least one buffer portion 125 is provided on the first side wall 141, the second side wall 142, and the third side wall 143 to further improve the buffering capacity of the inner frame 1 and effectively protect the diffuser plate from damage or abnormal warping.

The inner frame 1 further includes an adhesive member 15 arranged on the fourth bearing surface 112d. The bearing surface 112 and the diffuser plate 21 are fixedly connected by the adhesive member 15. The adhesive member 15 fixes one end of the diffuser plate 21 on the fourth bearing surface 112d, prevents displacement of the diffuser plate 21, and forces one end of the diffuser plate 21 to bend according to a preset curvature. The adhesive member 15 can be a double-sided tape.

FIG. 5 shows a top view of the inner frame 1 when the optical component 2 is not placed. The buffer portion 125 is not squeezed by an external force at this time, and the buffer groove 125a is not deformed.

FIG. 9 shows a top view of the optical component 2 when it is heated and expanded after being placed in the accommodation space 124 from the opening 121.

The diffuser plate 21 is placed on the bearing surface 112. The surface of the diffuser plate 21 close to the bearing surface 112 contacts the first bearing surface 112a, the second bearing surface 112b, the third bearing surface 112c, and the fourth bearing surface 112d to realize the stable support of the bearing surface 112 to the optical component 2. The surface of the diffuser plate 21 away from the bearing surface 112 is in contact with the limiting surface 123 formed by the plurality of protrusion portions 122. The three side surfaces of the diffuser plate 21 respectively abut against the first side wall 141, the second side wall 142, and the third side wall 143. The side of the diffuser plate 21 facing the fourth side wall 144 is fixed on the fourth bearing surface 112d by the adhesive member 15.

In the horizontal direction, the surfaces of first side wall 141, the second side wall 142, and the third side wall 143 close to the optical component 2 and the adhesive member 15 on the fourth side wall 144 jointly complete the limitation and fixation of the optical component 2, which prevents the optical component 2 from being displaced in the horizontal direction. In addition, at least one buffer portion 125 can be provided on the first side wall 141, the second side wall 142, and the third side wall 143 of the inner frame 1 to buffer the external force that the optical component 2 bears in the horizontal direction and the pressure generated by the thermal deformation thereof. When the temperature of the display device 100 rises, the diffuser plate 21 will expand and deform due to heat, and the buffer portion 125 can prevent the diffuser plate 21 from being abnormally warped due to the expansion. When the buffer portion 125 bears the external force applied by the diffuser plate 21, the buffer groove 125a will undergo compression deformation as shown in FIG. 9 to achieve buffering.

In a height direction perpendicular to the bearing surface 112, the limiting surface 123 formed by the plurality of protrusion portions 122 and the bearing surface 112 jointly complete the limitation and fixation of the optical component 2, which prevents the displacement of the optical component 2 in the height direction. In this embodiment, because the curvatures of the bearing surface 112 and the limiting surface 123 matches the preset curvature of the optical component 2, and the distance between the bearing surface 112 and the limiting surface 123 matches the thickness of the optical component 2, the optical component 2 will be bent according to a preset curvature under the limiting action of the bearing surface 112 and the limiting surface 123, and the preset curvature will always be kept unchanged.

In this application, the bearing surface 112 and the limit surface 123 of the inner frame 1 are designed as curved surfaces, and the distance between the bearing surface 112 and the limiting surface 123 is determined according to the thickness of the optical component 2, which ensures that the optical component 2 is bent under the limiting action of the bearing surface 112 and the limiting surface 123, and the bending curvature is always kept constant. This design of the present application fills the gap in the industry in which the optical components are bent according to the preset curvature in the module manufacturing process. The curved optical component matching the curvature of the curved display panel can be obtained by the current module manufacturing process without adding an additional manufacturing process, which greatly improves the optical performance of the large-size curved display device.

The above is a detailed introduction to a display device provided by the embodiment of the present application. This article describes the principles and implementation of the application through specific examples. The description of the above examples is only used to help understand the methods and core ideas of the application. In addition, for those skilled in the art, according to the idea of this application, there will be changes in the specific implementation and the scope of this application. As mentioned above, the content of this specification should not be construed as a limitation to this application.

What is claimed is:

1. A display device, comprising an inner frame and an optical component, wherein the inner frame comprises a bearing surface for carrying the optical component and a limiting surface for limiting the optical component, and the limiting surface and the bearing surface are arranged opposite to define an accommodation space to accommodate the optical component; the bearing surface and the limiting surface are both curved surfaces, and a distance between the bearing surface and the limiting surface matches a thickness of the optical component.

2. The display device according to claim 1, wherein the inner frame comprises a bottom frame and a limiting frame arranged in a stack, the bearing surface comprises a surface of the bottom frame facing the optical component, and the limiting surface comprises a surface of the limiting frame facing the optical component;
the inner frame comprises a first side wall, a second side wall, and a third side wall, the first side wall is disposed opposite to the third side wall, the second side wall is connected between the first side wall and the third side wall; and the first side wall, the second side wall, the third side wall, the bearing surface, and the limiting surface jointly define the accommodation space; and
the limiting frame further comprises at least one protrusion portion, the protrusion portion is disposed on the first side wall and/or the third side wall, a protruding direction of the protrusion portion faces a side wall opposite to the protrusion portion, and the limiting surface comprises a surface of the protrusion portion facing the bearing surface.

3. The display device according to claim 2, wherein the protrusion portion has a first end and a second end, the first end is an end of the protrusion portion connected to the first side wall or the third side wall, the second end is a free end of the protrusion portion, and a cross-sectional area of the first end is greater than a cross-sectional area of the second end.

4. The display device according to claim 2, wherein a surface of the protrusion portion away from the bearing surface is flush with an upper surface of the first side wall or an upper surface of the third side wall.

5. The display device according to claim 2, wherein both the first side wall and the third side wall are provided with the protrusion portions distributed at intervals, the limiting surface comprises surfaces of the protrusion portions close to the bearing surface, and the surface of each protrusion portion close to the bearing surface is a curved surface; and
the display device further comprises a display panel disposed on the optical component, and a distance between the protrusion portion far away from a side wall of the inner frame and the display panel is greater than a distance between the protrusion portion close to the side wall of the inner frame and the display panel.

6. The display device according to claim 1, wherein the inner frame comprises a bottom frame and a limiting frame arranged in a stack, the bearing surface comprises a surface of the bottom frame facing the optical component, and the limiting surface comprises a surface of the limiting frame facing the optical component;
the inner frame comprises a first side wall, a second side wall, a third side wall, and a fourth side wall connected in sequence, the first side wall is disposed opposite to the third side wall, and the first side wall, the second side wall, the third side wall, the bearing surface, and the limiting surface jointly define the accommodation space; and
the accommodation space has an opening above the fourth side wall, the accommodation space communicates with outside of the inner frame through the opening, an adhesive member is provided on the fourth side wall, and one end of the optical component is fixed to the inner frame through the adhesive member.

7. The display device according to claim 1, wherein the inner frame comprises a first side wall, a second side wall, and a third side wall, the first side wall and the third side wall are arranged opposite to each other, and the first side wall, the second side wall, the third side wall, the bearing surface, and the limiting surface jointly define the accommodation space; and
the inner frame further comprises at least one buffer portion located on one or more of the first side wall, the second side wall, and the third side wall, and the buffer portion abuts against a side surface of the optical component.

8. The display device according to claim 7, wherein the buffer portion is disposed on the second side wall, and the buffer portion comprises a buffer groove formed on the second side wall; and
a surface of the second side wall facing the accommodation space abuts against the side surface of the optical component.

9. The display device according to claim 8, wherein a surface of the second side wall close to the accommodation space protrudes toward the accommodation space to form a protrusion portion, an orthographic projection of the protrusion portion on the second side wall overlaps the buffer groove, one end of the protrusion portion extends to the bearing surface, and another end of the protrusion portion extends in a direction away from the bearing surface.

10. The display device according to claim 9, wherein a surface of the protrusion portion facing the accommodation space is a curved surface, and a distance between a vertex of the curved surface of the protrusion portion facing the accommodation space and the bearing surface is half of a thickness of a diffuser plate in the optical component.

11. The display device according to claim 1, wherein the distance between the bearing surface and the limiting surface matches the thickness of the optical component comprises: the accommodation space accommodates the optical component, and the optical component is bent according to a preset curvature under a limiting action of the bearing surface and the limiting surface.

12. A display device, comprising an inner frame and an optical component, wherein the inner frame comprises a bearing surface for carrying the optical component and a limiting surface for limiting the optical component, the inner frame comprises a bottom frame and a limiting frame arranged in a stack, the bearing surface comprises a surface of the bottom frame facing the optical component, and the limiting surface comprises a surface of the limiting frame facing the optical component;
the limiting surface and the bearing surface are arranged opposite to define an accommodation space to accommodate the optical component; the bearing surface and the limiting surface are both curved surfaces, and the optical component is bent according to a preset curvature under a limiting action of the bearing surface and the limiting surface;
the inner frame comprises a first side wall, a second side wall, and a third side wall, the first side wall and the third side wall are arranged opposite to each other, and the second side wall is connected between the first side wall and the third side wall; and the first side wall, the second side wall, the third side wall, the bearing surface, and the limiting surface jointly define the accommodation space.

13. The display device according to claim 12, wherein the limiting frame further comprises at least one protrusion portion, the protrusion portion is disposed on the first side wall and/or the third side wall, a protruding direction of the protrusion portion faces a side wall opposite to the protrusion portion, and the limiting surface comprises a surface of the protrusion portion facing the bearing surface.

14. The display device according to claim 13, wherein a thickness of the protrusion portion ranges from 0.5 mm to 1 mm.

15. The display device according to claim 12, wherein the inner frame further comprises at least one buffer portion located on one or more of the first side wall, the second side wall, and the third side wall, and the buffer portion abuts against a side surface of the optical component.

16. The display device according to claim 12, wherein the buffer portion is disposed on the second side wall, and the buffer portion comprises a buffer groove formed on the second side wall;
a surface of the second side wall close to the accommodation space protrudes toward the accommodation space to form a protrusion portion, an orthographic projection of the protrusion portion on the second side wall overlaps the buffer groove, one end of the protrusion portion extends to the bearing surface, and another end of the protrusion portion extends in a direction away from the bearing surface.

17. The display device according to claim 16, wherein a surface of the protrusion portion facing the accommodation space is a curved surface, and a distance between a vertex of the curved surface of the protrusion portion facing the accommodation space and the bearing surface is half of a thickness of a diffuser plate in the optical component.

18. The display device according to claim 12, wherein the inner frame comprises the first side wall, the second side wall, the third side wall, and a fourth side wall connected in sequence, and the second side wall is opposite to the fourth side wall; and
the accommodation space has an opening above the fourth side wall, the accommodation space communicates with outside of the inner frame through the opening, an adhesive member is provided on the fourth side wall, and one end of the optical component is fixed to the inner frame through the adhesive member.

19. The display device according to claim 18, wherein each of the first side wall, the second side wall, and the third side wall comprises a bottom frame side wall and a limiting frame side wall, the fourth side wall comprises a bottom frame side wall, and the opening extends from above the fourth side wall to above the bottom frame side wall of the first side wall and above the bottom frame side wall of the third side wall; and
the bottom frame side walls of the first side wall, the second side wall, the third side wall, and the fourth side wall encircle to form a light source accommodation space, and the light source accommodation space accommodates a light source assembly; the limiting frame side walls of the first side wall, the second side wall, and the third side wall encircle to form the accommodation space.

20. The display device according to claim 12, wherein a distance between the bearing surface and the limiting surface is a fixed value.
